(19) United States
(12) Patent Application Publication
(10) Pub. No.: US 2026/0046788 A1
(43) Pub. Date: Feb. 12, 2026

(54) METHOD FOR DYNAMICALLY ADJUSTING TRANSMITTING POWER LIMIT OF RADIO MODULE AND ASSOCIATED RADIO MODULE

(71) Applicant: MEDIATEK INC., Hsinchu City (TW)

(72) Inventors: Yi-Ying Huang, Hsinchu City (TW); Chun-Hsiang Chen, Hsinchu City (TW); Yi-Hsuan Lin, Hsinchu City (TW); Wei-Yu Chung, Hsinchu City (TW); Jia-Jyun Jin, Hsinchu City (TW)

(73) Assignee: MEDIATEK INC., Hsinchu City (TW)

(21) Appl. No.: 19/292,889

(22) Filed: Aug. 6, 2025

Related U.S. Application Data
(60) Provisional application No. 63/680,093, filed on Aug. 7, 2024.

(51) Int. Cl. H04W 52/36

(52) U.S. Cl. CPC H04W 52/367

(57) ABSTRACT

A method for dynamically adjusting a transmitting (TX) power limit of a radio module includes: obtaining at least one message of the radio module or at least one message of at least one other radio module, for acting as TX power reference information; determining a scenario of a TX power of the radio module according to the TX power reference information; and determining the TX power limit of the radio module according to the scenario.

### CROSS REFERENCE TO RELATED APPLICATIONS

This application claims the benefit of U.S. Provisional Application No. 63/680,093, filed on Aug. 7, 2024. The content of the application is incorporated herein by reference.

### BACKGROUND

The present disclosure is related to radio frequency (RF) technology, and more particularly, to a method for dynamically adjusting a transmitting (TX) power limit of a radio module and an associated radio module.

Nowadays, the RF technology has often appeared in a user equipment (UE; such as a mobile phone). However, excessive RF exposure may cause harm to human body. As a result, officials of different countries (e.g. federal communications commission (FCC) of USA, innovation, science, and economic development (ISED) of Canada, and conformite europeenne (CE) of Europe) regulate a time-averaged RF exposure limit to limit a time-averaged RF exposure of a radio module in the UE. For example, in response to a frequency band of the radio module being smaller than 6 GHz, the time-averaged RF exposure will be quantified with a time-averaged specific absorption rate (SAR). In response to the frequency band of the radio module being not smaller than 6 GHz, the time-averaged RF exposure will be quantified with a time-averaged power density (PD). In addition, since the time-averaged RF exposure will be proportional to a TX power of the radio module, the time-averaged RF exposure can meet the time-averaged RF exposure limit by controlling the TX power.

How to set a TX power limit of a radio module to ensure that an RF exposure of the radio module will not exceed the regulatory limit across various scenarios has become a critical issue. Existing methods typically consider the worst-case scenario across multiple scenarios. More particularly, the TX power limit of the radio module is set/determined based on the worst-case measured TX power limit in any scenario, which affects the user's experience in certain scenarios.

### SUMMARY

It is therefore one of the objectives of the present disclosure to provide a method for dynamically adjusting a TX power limit of a radio module and an associated radio module, in order to address the above-mentioned issues.

According to an embodiment of the present disclosure, a method for dynamically adjusting a TX power limit of a radio module is provided. The method comprises: obtaining at least one message of the radio module or at least one message of at least one other radio module, for acting as TX power reference information; determining a scenario of a TX power of the radio module according to the TX power reference information; and determining the TX power limit of the radio module according to the scenario.

According to an embodiment of the present disclosure, a radio module for dynamically adjusting a TX power limit of the radio module is provided. The radio module comprises a controller and a transceiver. The controller is arranged to: obtain at least one message of the radio module or at least one message of at least one other radio module, for acting as TX power reference information; determine a scenario of a TX power of the radio module according to the TX power reference information; and determine the TX power limit of the radio module according to the scenario. The transceiver is arranged to perform a TX operation based on the TX power limit of the radio module.

One of the benefits of the present disclosure is that, for different scenarios involving in at least one of a TX antenna tuner codeword (CW), a receiving (RX) antenna tuner CW, a channel frequency range, a modulation method, or an exposure condition of a radio module, the method of the present disclosure can dynamically adjust a TX power limit of the radio module based on the determined scenario, in order to ensure that an RF exposure of the radio module will not exceed the regulatory limit across various scenarios. Compared with a case where the TX power limit of the radio module is set/determined based on the worst-case measured TX power limit, the method of the present disclosure can maximize power utilization under any scenario.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating interaction between two radio modules according to an embodiment of the present disclosure.

FIG. 2 is a diagram illustrating an example of a TX power limit of a radio module for body SAR under different scenarios.

FIG. 3 is a flow chart of a method for dynamically adjusting a TX power limit of a radio module according to an embodiment of the present disclosure.

FIG. 4 is a block diagram of a radio module according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

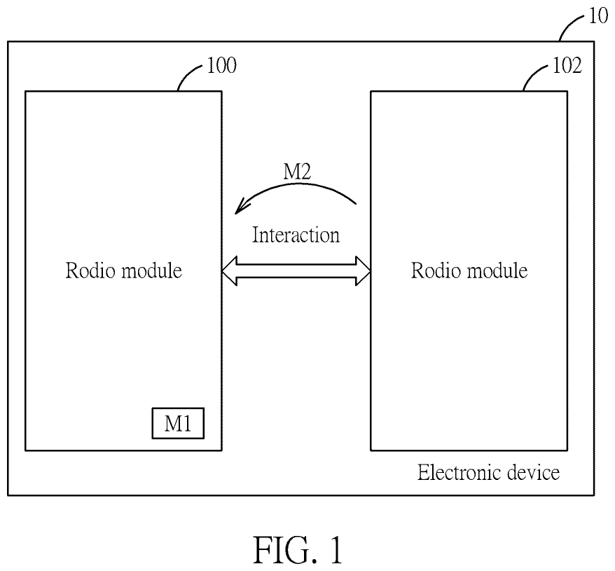

FIG. 1 is a diagram illustrating an electronic device 10 according to an embodiment of the present invention. By way of example, but not limitation, the electronic device 10 may be a portable device such as a smartphone, a wearable device, or a tablet. As shown in FIG. 1, the electronic device 10 may include two radio modules 100 and 102. FIG. 1 shows interaction between two radio modules 100 and 102 according to an embodiment of the present disclosure. By way of example, but not limitation, each of the radio modules 100 and 102 may include communication circuits corresponding to sub-6, millimeter wave (mmWave), wireless fidelity (Wi-Fi), bluetooth (BT), Zigbee, global positioning system (GPS), vehicle to everything (V2X), and/or non-terrestrial networks (NTN).

The radio module 100 may be arranged to receive a time-averaged (TA) RF exposure limit regulated by officials, wherein the TA RF exposure limit corresponds to the radio module 100. Since the TA RF exposure limit is proportional to a transmitting (TX) power limit of the radio module 100, the radio module 100 may be further arranged to map the TA RF exposure limit to a TX power limit TPL1 of the radio module 100. Specifically, the TA RF exposure limit may be a total exposure ratio (TER), wherein the TER may include a normalized average specific absorption rate (SAR) limit and a normalized average power density (PD) limit, and the TER is required to be less than or equal to 1 (i.e., TER≤1). The radio module 100 may utilize a test or a simulation to find a first normalized average TX power limit mapped to the normalized average SAR limit and a second normalized average TX power limit mapped to the normalized average PD limit, wherein the TX power limit TPL1 includes the first normalized average TX power limit and the second normalized average TX power limit. However, this is for illustration only, and the present disclosure is not limited thereto. In some embodiments, the user may directly utilize the test or the simulation to find the TX power limit TPL1. That is, the TA RF exposure limit may also be mapped to the TX power limit TPL1 of the radio module 100 directly by the user.

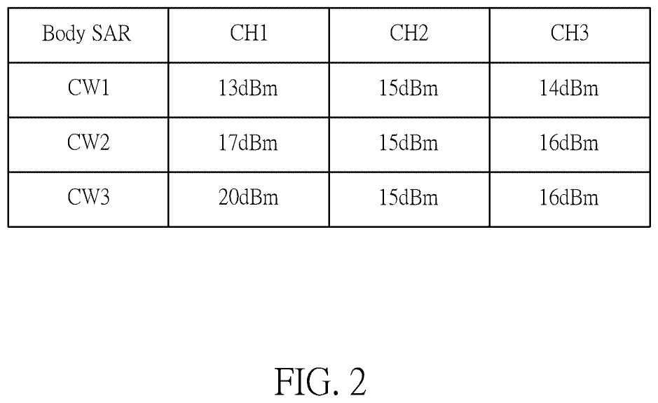

It should be noted that, for a radio module, a scenario may involve in at least one of multiple factors including a TX antenna tuner codeword (CW), a receiving (RX) antenna tuner CW, a channel frequency range, a modulation method and an exposure condition of the radio module, and the scenario may affect RF exposure. For example, different exposure conditions may correspond to SAR limits of different parts of the human. However, this is for illustrative purposes only, and is not meant to be as a limitation of the present disclosure. The TX/RX antenna tuner CW may be considered as a tuner setting. Different TX tuner CWs will have different antenna gains to affect the TX power. Take FIG. 2 as an example. FIG. 2 is a diagram illustrating an example of the TX power limit TPL1 of the radio module 100 for body SAR under different scenarios. FIG. 2 involves two dimensions, i.e., the TX antenna tuner CW and the channel frequency range. Assume that settings of the radio modules 100 include three TX antenna tuner CWs CW1, CW2, and CW3 and three channel frequency ranges corresponding to different frequency ranges (e.g., three channel frequency ranges CH1, CH2, and CH3 that respectively correspond to a high frequency range, a middle frequency range, and a low frequency range) In this embodiment, nine scenarios involving in different TX/RX antenna tuner CWs and different channel frequency ranges exist, and each scenario may correspond to a different value of the TX power limit TPL1. For example, under a scenario with the TX antenna tuner CW CW1 and the channel frequency range CH1, the TX power limit TPL1 of the radio module 100 is 13 dBm. Under a scenario with the TX antenna tuner CW CW1 and the channel frequency range CH2, the TX power limit TPL1 of the radio module 100 is 15 dBm. The remaining scenarios shown in FIG. 2 are not described in detail here for brevity.

In order to determine which scenario SCE_O the TX power of the radio module 100 belongs to, the radio module 100 may collect/obtain at least one message M1 corresponding to the radio module 100 and/or at least one message M2 corresponding to the radio module 102 for acting as TX power reference information, and determine the scenario SCE_O according to the TX power reference information, wherein the at least one message M2 is received from the radio module 102 by interacting with the radio module 102, and the at least one message M1 is obtained or calculated by the radio module 100.

For example, the radio module 100 may determine the scenario SCE_O according to only the at least one message M2. In another example, the radio module 100 may determine the scenario SCE_O according to both the at least one message M1 and the at least one message M2. In some embodiments, under a condition that the radio module 100 is not able to receive the at least one message M2 from the radio module 102 due to some reasons, the radio module 100 may determine the scenario SCE_O according to only the at least one message M1. In some embodiments, after the radio module 100 receives the at least one message M2 from the radio module 102 by interacting with the radio module 102, the at least one message M2 may be stored in a memory (not shown in FIG. 1), and the radio module 100 may determine the scenario SCE_O according to only the at least one message M1. These alternative designs all fall within the scope of the present disclosure. In some embodiments, the at least one message M2 may influence the TX/RX tuner CW of the radio module 100.

In this embodiment, the interaction for exchanging messages is performed between two radio modules (e.g., the radio modules 100 and 102). However, this is for illustrative purposes only, and is not meant to be as a limitation of the present disclosure. In some embodiments, the interaction can be performed between more than two radio modules. In practice, any radio module that is capable of interacting with at least one other radio module to receive the at least one message M2, and determining the scenario SCE_O according to the at least one message M1 and/or the at least one message M2, can be employed by the radio module 100.

The at least one message M1 and the at least one message M2 may include an on/off status of the radio module 100 and an on/off status of the radio module 102, respectively, wherein the off status represents that corresponding radio module has not performed a TX operation for a period of time (e.g., the corresponding radio module is in a shutdown mode, a flight mode, a sleep mode, a discontinuous transmission (DTX) mode, a call drop mode, or a no subscriber identity module (SIM) card mode), and the on status represents that the corresponding radio module is not in the off status. For example, when the corresponding radio module is not in any of the shutdown mode, the flight mode, the sleep mode, the DTX mode, the call drop mode, and the no SIM card mode, the corresponding radio module is in the on status. In addition, each of the at least one message M1 and the at least one message M2 may further include some information of the corresponding radio module. By way of example, but not limitation, the information of the corresponding radio module may include a previous/current available normalized average TX power ratio, a needed normalized average TX power ratio, a normalized average TX power ratio margin, one or more TX performance indices, one or more receiving (RX) performance indices, weighting information from a user, user behavior information, or one or more configurations. For example, the weighting information from the user may be the weights of the instantaneous TX power of the radio module 100 for TX operations of different frequency bands.

The one or more TX performance indices may include at least one of a duty cycle of TX, an error vector magnitude (EVM) of TX, a target power of TX, a throughput of TX, a modulation and coding scheme (MCS) of TX, a block error rate (BLER) of TX, a resource block (RB) of TX, a transmission block size (TBS) of TX, and a TX packet error rate (TX PER).

The one or more RX performance indices may include at least one of a duty cycle of RX, an MCS of RX, a received signal strength indication (RSSI), a reference signal receiving power (RSRP), a signal to noise ratio (SNR) of RX, a signal to interference and noise ratio (SINR) of RX, and an RX packet error rate (RX PER).

The one or more configurations may be related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, a combination of the band and an SIM, a TER group index, a SAR to peak location separation ratio (SPLSR) group index, TX/RX antenna tuner CW information, and a channel frequency range type. The one or more exposure condition indices may be used for determining an exposure condition.

The user behavior information may be related to at least one of gaming, application (APP) information, a head-hand effect, and data/voice transmission of the user. The head-hand effect indicates whether the radio module 100 is close to the head or the hand.

The radio module 100 may determine the scenario SCE_O according to the at least one message M1 and/or the at least one message M2, and more particularly, may select multiple related scenarios from multiple predetermined candidate scenarios stored in the memory according to the above-mentioned message(s). In addition, the radio module 100 may set a weight/priority for each related scenario according to the information for determining the weight/priority, for determining the scenario SCE_O from the multiple related scenarios according to multiple weights/priorities.

It should be noted that, the radio module 100 may further access/read a predetermined power limit table and/or a predetermined power limit offset table from the memory, wherein the predetermined power limit table records a corresponding power limit of each predetermined candidate scenario, and the predetermined power limit offset table records a corresponding power limit offset of each predetermined candidate scenario. The radio module 100 may select a power limit from the predetermined power limit table according to the scenario SCE_O, or select a power limit offset from the predetermined power limit offset table according to the scenario SCE_O, for dynamically adjusting the TX power limit TPL1 of the radio module 100 according to different scenarios. That is, the radio module 100 may obtain a power limit corresponding to the determined scenario SCE_O from the predetermined power limit table or obtain a power limit offset corresponding to the determined scenario SCE_O from the predetermined power limit offset table. If the radio module 100 obtains the power limit offset corresponding to the determined scenario SCE_O, it may obtain a power limit corresponding to the determined scenario SCE_O based on the power limit offset and a baseline power value.

The selection operations of multiple related scenarios from multiple predetermined candidate scenarios stored in the memory may be performed based on the above-mentioned message(s). Specifically, based on the above-mentioned message(s), one or more values of each factor involved in a scenario can be determined. The multiple related scenarios corresponding to combinations of values of various factors involved are selected from the predetermined power limit table or the predetermined power limit offset table.

The radio module 100 may set a weight (also referred to as priority) for each related scenario according to information used for determining a weight/priority in at least one message M1 of the radio module 110 and/or at least one message M2 of at least one other radio module, for determining the scenario SCE_O from the multiple related scenarios according to multiple weights/priorities. Specifically, each scenario among multiple related scenarios has a base weight/priority value. When it is determined, based on the information used for determining a weight/priority, that a factor with a certain value in a scenario is preferred, the weight/priority of that scenario is increased. If it is further determined, based on the information used for determining a weight/priority, that another factor with a certain value in the scenario is also preferred, the weight/priority of the scenario is increased again. In this way, a weight/priority for each related scenario is set. The information used for determining a weight may include data/voice transmission, customized weights/priorities, a target power of TX, a band, etc. For example, if the radio module performs voice transmission, the scenario with TX/RX antenna tuner CW that results in a high antenna gain has a higher weight. In another example, customized weights/priorities are set for each of the multiple related scenarios. However, this is for illustrative purposes only, and is not meant to be as a limitation of the present disclosure.

Take FIG. 2 as an example. The predetermined candidate scenarios may be nine scenarios shown in FIG. 2. The predetermined power limit table may record a corresponding power limit of each scenario for the body SAR (e.g., 13 dBm corresponding to the scenario with the TX antenna tuner CW CW1 and the channel CH1). By referring to the predetermined power limit table, the radio module 100 may determine the TX power limit TPL1 of the radio module 100 according to the determined scenario and the corresponding power limit, such that different TX power limit TPL1 may be applied to the radio module 100 for different scenario.

In order to prevent an average TX power of the radio module 100 from exceeding the TX power limit TPL1, the radio module 100 may be further arranged to perform TX power switching between multiple power levels according to the TX power limit TPL1. In this way, it is ensured that the RF exposure of the radio module 100 complies with regulatory limits under any scenario. Specifically, the radio module 100 may determine multiple power levels of the TX power of the radio module 100 according to the scenario SCE_O. For example, the radio module 100 may determine the maximum instantaneous TX power and the minimum backoff TX power according to the scenario SCE_O, and determine multiple power levels between the maximum instantaneous TX power and the minimum backoff TX power. Afterwards, the radio module 100 may control an instantaneous TX power of the radio module 100 to make an average TX power of the radio module 100 lower than or equal to the TX power limit TPL1, wherein the instantaneous TX power is switched between the power levels, and the instantaneous TX power is also referred to as an instantaneous power state of the radio module 100. With this arrangement, time-averaged (TA) RF exposure limit violations are avoided for any scenarios. Regarding each of the one or more configurations, the TX power of the radio module 100 may be normalized to generate a normalized TX power, and it is determined that which of the power levels the normalized TX power belongs to, for avoiding exceeding the TX power limit TPL1.

For example, during a process of switching from the minimum backoff TX power to the maximum instantaneous TX power, the TX power of the radio module 100 is controlled to be switched from the minimum power level (i.e., the minimum backoff TX power) to the maximum power level (i.e., the maximum instantaneous TX power) directly or in sequence. During a process of switching from the maximum instantaneous TX power to the minimum backoff TX power, the TX power of the radio module 100 is controlled to be switched from the maximum power level to the minimum power level directly or in sequence.

In an embodiment, the radio module 100 may be further arranged to perform the TX power reference information calculation/determination according to the TX power limit TPL1. For example, the radio module 100 may calculate associated messages (e.g., the above-mentioned at least one message M1) and determine available normalized TX power ratios, for recording in the memory. Since the TX power reference information calculation/determination is well known to those skilled in the art, further descriptions are omitted here for brevity.

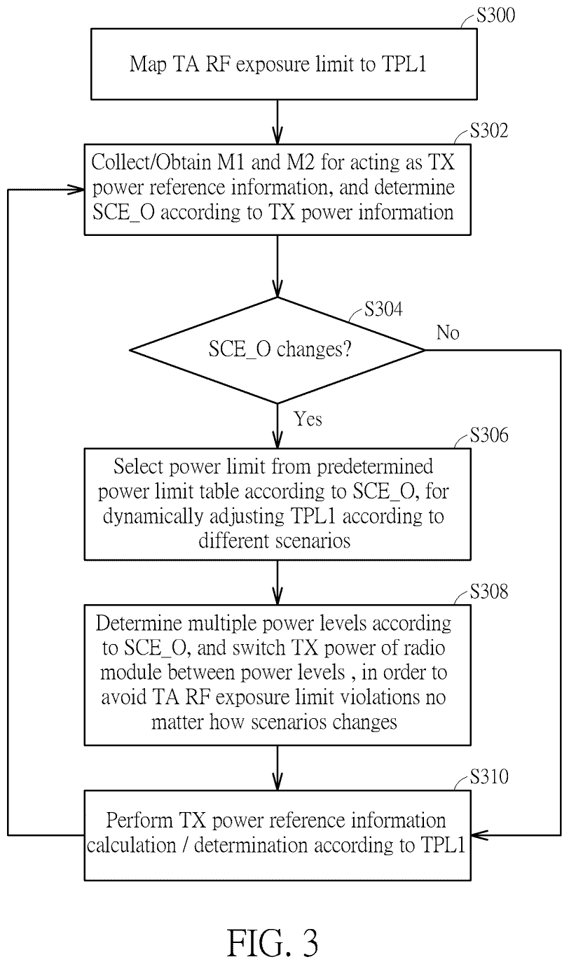

FIG. 3 is a flow chart of a method for dynamically adjusting the TX power limit TPL1 of the radio module 100 according to an embodiment of the present disclosure. Provided that the result is substantially the same, the steps are not required to be executed in the exact order shown in FIG. 3. For example, the method shown in FIG. 3 may be employed by the radio module 100 shown in FIG. 1. In some embodiments, one or more steps may be added, deleted, or changed in the flow shown in FIG. 3.

In Step S300, the TA RF exposure limit corresponding to the radio module 100 is mapped to the TX power limit TPL1.

In Step S302, the at least one message M1 and/or the at least one message M2 are collected/obtained for acting as TX power reference information, and the scenario SCE_O of the radio module 100 is determined according to the TX power reference information.

In Step S304, it is determined whether the scenario SCE_O changes, and more particularly, whether the scenario SCE_O is different from a previous scenario (or a predetermined scenario). If Yes, Step S306 is entered; if No, Step S310 is entered.

In Step S306, a power limit is selected from a predetermined power limit table according to the scenario SCE_O, for dynamically adjusting the TX power limit TPL1 according to different scenarios. In some embodiments, a power limit offset may be selected from a predetermined power limit offset table according to the scenario SCE_O, for dynamically adjusting the TX power limit TPL1 according to different scenarios.

In Step S308, multiple power levels is determined according to the scenario SCE_O, and the TX power of the radio module 100 is switched between the power levels, in order to avoid TA RF exposure limit violations no matter how scenarios changes.

In Step S310, the TX power reference information calculation/determination is performed according to the TX power limit TPL1. For example, the at least one message M1 (e.g., available normalized TX power ratios) can be calculated/determined according to the TX power limit TPL1 for determining the scenario SCE_O of the radio module 100 (Step S302).

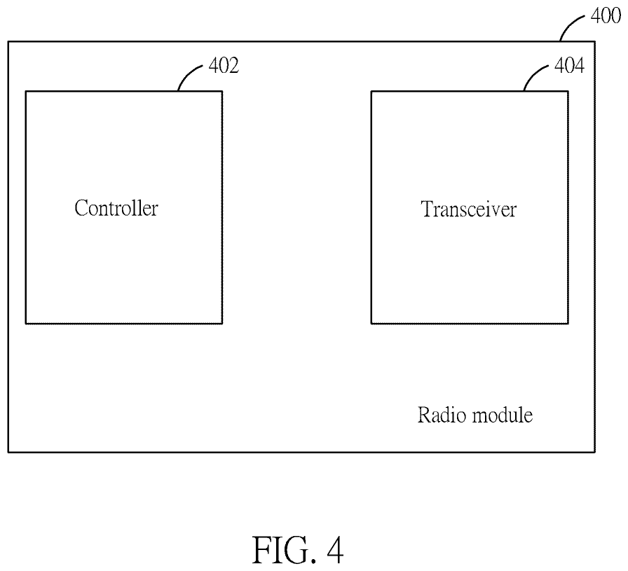

FIG. 4 is a block diagram of a radio module 400 according to an embodiment of the present disclosure, wherein each of the radio modules 100 and 102 shown in FIG. 1 may be implemented by the radio module 400. As shown in FIG. 4, the radio module 400 may include a controller 402 and a transceiver 404. The controller 404 is configured to obtain at least one message of the radio module 400 or at least one message of at least one other radio module for acting as TX power reference information, determine a scenario of a TX power of the radio module 400 according to the TX power reference information, and determine the TX power limit of the radio module 400 according to the scenario. The transceiver 404 is configured to perform a TX operation based on the TX power limit of the radio module 400.

Since a person skilled in the pertinent art can readily understand details of the steps after reading above paragraphs directed to the radio module 100 shown in FIG. 1, further descriptions are omitted here for brevity.

In summary, for different scenarios involving in at least one of a TX/RX antenna tuner CW, a channel frequency range, a modulation method, or an exposure condition of a radio module, the method of the present disclosure can dynamically adjust a TX power limit of the radio module based on the determined scenario, in order to ensure that an RF exposure of the radio module will not exceed the regulatory limit across various scenarios. Compared with a case where the TX power limit of the radio module is set/determined based on the worst-case measured TX power limit, the method of the present disclosure can maximize power utilization under any scenario.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for dynamically adjusting a transmitting (TX) power limit of a radio module, comprising:
obtaining at least one message of the radio module or at least one message of at least one other radio module, for acting as TX power reference information;
determining a scenario of a TX power of the radio module according to the TX power reference information; and
determining the TX power limit of the radio module according to the scenario.

2. The method of claim 1, wherein the scenario involves in at least one of a TX antenna tuner codeword (CW), a receiving (RX) antenna tuner CW, a channel frequency range, a modulation method, and an exposure condition of the radio module.

3. The method of claim 1, wherein the TX power reference information comprises information used for determining a weight, and the step of determining the scenario of the TX power of the radio module according to the TX power reference information comprises:
selecting multiple related scenarios from multiple predetermined candidate scenarios according to the TX power reference information; and
setting the weight for each of the multiple related scenarios according to the information, for determining the scenario from the multiple related scenarios according to multiple weights.

4. The method of claim 3, wherein the step of determining the TX power limit of the radio module according to the scenario comprises:
selecting a power limit from a predetermined power limit table according to the scenario for acting as a selected power limit, wherein the predetermined power limit table records a corresponding power limit of each of the multiple predetermined candidate scenarios; and
setting the TX power limit of the radio module as the selected power limit.

5. The method of claim 3, wherein the step of determining the TX power limit of the radio module according to the scenario comprises:
selecting a power limit offset from a predetermined power limit offset table according to the scenario for acting as a selected power limit offset, wherein the predetermined power limit offset table records a corresponding power limit offset of each of the multiple predetermined candidate scenarios; and
determining the TX power limit of the radio module according to the selected power limit offset and a baseline power value.

6. The method of claim 1, further comprising:
determining multiple power levels according to the scenario; and
determining a TX power of the radio module, wherein the TX power of the radio module is switched between the multiple power levels.

7. The method of claim 1, wherein the at least one message of the radio module or the at least one message of the at least one other radio module comprises a previous available normalized average TX power ratio, a current available normalized average TX power ratio, a normalized average TX power ratio margin, one or more TX performance indices, one or more receiving (RX) performance indices, weighting information, one or more configurations, user behavior information, or an on/off status of a corresponding radio module.

8. The method of claim 7, wherein the at least one message of the at least one other radio module or the at least one message of the radio module comprises the one or more TX performance indices, comprising at least one of a duty cycle of TX, an error vector magnitude (EVM) of TX, a target power of TX, a throughput of TX, a modulation and coding scheme (MCS) of TX, a block error rate (BLER) of TX, a resource block (RB) of TX, a transmission block size (TBS) of TX, and a TX packet error rate (TX PER).

9. The method of claim 7, wherein the at least one message of the at least one other radio module or the at least one message of the radio module comprises the one or more RX performance indices, comprising at least one of a duty cycle of RX, a modulation and coding scheme (MCS) of RX, a received signal strength indication (RSSI), a reference signal RX power (RSRP), a signal to noise ratio (SNR) of RX, a signal to interference and noise ratio (SINR) of RX, and an RX packet error rate (RX PER).

10. The method of claim 7, wherein the at least one message of the at least one other radio module or the at least one message of the radio module comprises the one or more configurations related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, a combination of the band and a subscriber identity module (SIM), a total exposure ratio (TER) group index, a specific absorption rate (SAR) to peak location separation ratio (SPLSR) group index, a TX or RX antenna tuner codeword (CW) information, and a channel frequency range type.

11. The method of claim 3, wherein the scenario involves in at least one of multiple factors comprising a TX or RX antenna tuner codeword (CW), a channel frequency range, a modulation method, and an exposure condition of the radio module; and the step of selecting the multiple related scenarios from the multiple predetermined candidate scenarios according to the TX power reference information comprises:
determining one or more values of each factor among the multiple factors according to the TX power reference information; and
selecting the multiple related scenarios corresponding to combinations of values of the multiple factors from the multiple predetermined candidate scenarios.

12. A radio module for dynamically adjusting a transmitting (TX) power limit of the radio module, comprising:
a controller, arranged to:
obtain at least one message of the radio module or at least one message of at least one other radio module, for acting as TX power reference information;
determine a scenario of a TX power of the radio module according to the TX power reference information; and
determine the TX power limit of the radio module according to the scenario; and
a transceiver, arranged to perform a TX operation based on the TX power limit of the radio module.

13. The radio module of claim 12, wherein the scenario involves in at least one of a TX antenna tuner codeword (CW), a receiving (RX) antenna tuner CW, a channel frequency range, a modulation method, and an exposure condition of the radio module.

14. The radio module of claim 12, wherein the TX power reference information comprises information used for determining a weight, and the controller is further arranged to:
select multiple related scenarios from multiple predetermined candidate scenarios according to the TX power reference information; and
set the weight for each of the multiple related scenarios according to the information, for determining the scenario from the multiple related scenarios according to multiple weights.

15. The radio module of claim 14, wherein the controller is further arranged to:
select a power limit from a predetermined power limit table according to the scenario for acting as a selected power limit, wherein the predetermined power limit table records a corresponding power limit of each of the multiple predetermined candidate scenarios; and
set the TX power limit of the radio module as the selected power limit.

16. The radio module of claim 14, wherein the controller is further arranged to:
select a power limit offset from a predetermined power limit offset table according to the scenario for acting as a selected power limit offset, wherein the predetermined power limit offset table records a corresponding power limit offset of each of the multiple predetermined candidate scenarios; and
determine the TX power limit of the radio module according to the selected power limit offset and a baseline power value.

17. The radio module of claim 12, wherein the controller is further arranged to determine multiple power levels according to the scenario, and determine a TX power of the radio module, wherein the TX power of the radio module is switched between the multiple power levels.

18. The radio module of claim 12, wherein the at least one message of the radio module or the at least one message of the at least one other radio module comprises a previous available normalized average TX power ratio, a current available normalized average TX power ratio, a normalized average TX power ratio margin, one or more TX performance indices, one or more receiving (RX) performance indices, weighting information, one or more configurations, user behavior information, or an on/off status of a corresponding radio module.

19. The radio module of claim 18, wherein the at least one message of the at least one other radio module or the at least one message of the radio module comprises the one or more TX performance indices, comprising at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

20. The radio module of claim 18, wherein the at least one message of the at least one other radio module or the at least one message of the radio module comprises the one or more RX performance indices, comprising at least one of a duty cycle of RX, a modulation and coding scheme (MCS) of RX, a received signal strength indication (RSSI), a reference signal RX power (RSRP), a signal to noise ratio (SNR) of RX, a signal to interference and noise ratio (SINR) of RX, and an RX packet error rate (RX PER).
